(19) United States
(12) Patent Application Publication
(10) Pub. No.: US 2015/0277734 A1
(43) Pub. Date: Oct. 1, 2015

(54) METHOD AND DEVICE FOR MANAGING AND CONFIGURING FIELD DEVICES IN AN AUTOMATION INSTALLATION (II)

(71) Applicant: ABB TECHNOLOGY AG, Zurich (CH)

(72) Inventors: Dirk WAGENER, Stadthagen (DE); Christoph WELTE, Neu-Ulm (DE); Marcus HEEGE, Kaisersesch (DE); Wolfgang MAHNKE, Hettenleidelheim (DE); Marko SCHLUTER, Espelkamp (DE)

(73) Assignee: ABB TECHNOLOGY AG, Zurich (CH)

(21) Appl. No.: 14/671,247

(22) Filed: Mar. 27, 2015

(30) Foreign Application Priority Data
Mar. 28, 2014 (DE) 10 2014 004479.3

(51) Int. Cl. G06F 3/0484

(52) U.S. Cl. CPC G06F 3/04847; G06F 3/04842

(57) ABSTRACT

An exemplary method and device provides for managing and configuring field devices in an automation installation with a configuration tool. The configuration tool is configured to physically detect a field device in the automation installation, logically incorporate the field device in the automation installation, and configure the field device in the automation installation. For this purpose, the configuration tool uses a predefined field-device-specific information packet that describes the functions and data of the field device and includes a display for displaying the functions and data of the field device in an instantiated manner in windows or dialogs. Windows of the same device entity for the same input context are grouped by a common marking and displayed in a superordinate window.

### RELATED APPLICATION(S)

This application claims priority under 35 U.S.C. §119 to German application 102014004479.3 filed on Mar. 28, 2014, the entire content of which is hereby incorporated by reference.

### FIELD

The disclosure relates to a method and a device for managing and configuring field devices in an automation installation. The disclosure is germane to process automation or machine control for controlling processes and/or installation components.

### BACKGROUND INFORMATION

Automation systems for controlling a technical process or a technical installation usually include a control device (PLC) which is integrated in a group of a multiplicity of intelligent electrical devices. Intelligent electronic devices are microprocessor-based devices, for example protective and control devices, motor protective devices, intelligent switches and voltage regulators, frequency converters, pressure and temperature measuring transducers, flowmeters and actuators.

The article “FDI Device Integration—Best of Both Worlds”, atp edition 6/2010, pages 16 to 19, discloses the practice of integrating field devices in an automation installation using the FDI concept (Field Device Integration IEC-62769). The basis of this concept is the provision of information for configuring field devices in a device-specific FDI packet. This FDI packet includes a firmly predefined amount of information which includes a device definition, business logic, a user interface description and user interface plug-ins. The device definition includes management information and the device model. The business logic describes the communication logic for the device and is used to ensure consistency of the device model. The user interface description describes the presentation of the device parameters and device functions. The user interface plug-ins are programmed components of interface portions for displaying the device parameters and functions.

When configuring field devices using EDD (electronic device description) technology IEC 61804, a device manufacturer provides an EDD which includes information relating to the communication with the device, the business logic and the user interfaces, such as which input masks should be displayed for a user. The business logic includes, for example, when which parameters can be written.

FDI technology uses these EDD mechanisms and provides the concept of the FDI package which, in addition to an EDD, may also include other information such as a user handbook or else so-called UIPs (user interface plug-in) which provide further user interfaces in other technologies, for example .NET assemblies, which, in contrast to EDD-based user interfaces, include programmed code compiled for a component.

FDI packets can be created by device manufacturers and are used by system manufacturers to integrate and configure the devices from the device manufacturers in their system.

In addition to an individual user element having different parameters, graphs and other elements, new windows and dialogs can be be defined in the EDD. In this case, a host can have certain freedoms and can display a plurality of menus defined in the EDD in different windows at the same time, for example, or else user interfaces of different device entities.

Known EDD host systems either restrict the number of windows or open an arbitrary number of windows for the different devices. In this case, the overview of the assignment of the windows to the devices is lost.

In addition, the EDD specification defines an input context including changes to a device configuration which have already been made by the user at the interface but have not yet been written to the device or the offline configuration by the user. According to the EDD specification, it is possible in this case for different windows and dialogs to work on different input contexts of the same device. This concept makes it even more difficult for a user to assign the windows not only to the device but also to a specified input context.

According to known implementations, EDD host systems display the windows described in the EDD as windows of the application, with the result that the user can compare a plurality of window contents with one another. However, it can be difficult to assign the windows to a specified device entity and more difficult to assign the windows to a specified input context of this device entity. If a user wishes to use or reject an input context, it, therefore, can be difficult to discern which windows are affected thereby.

### SUMMARY

An exemplary method for managing and configuring field devices in an automation installation with a configuration tool is disclosed, the configuration tool configured to physically detect a field device in the automation installation, logically incorporate the field device in the automation installation, and configure the field device in the automation installation using a predefined field-device-specific information packet which describes functions and data of the field device, the method comprising: displaying the functions and data of the field device in an instantiated manner using input windows or dialogs on a display means; and grouping the input windows of a same device entity and for a same input context by a common marking.

An exemplary device for managing and configuring field devices in an automation installation is disclosed, comprising: a processor configured to execute a configuration tool that physically detects a field device in the automation installation, logically incorporated the field device in the automation installation, and configure the field device in the automation installation using a predefined field-device-specific information packet which describes the functions and data of the field device; and display means for displaying the functions and data of the field device in an instantiated manner in input windows or dialogs, wherein the input windows of a same device entity and for a same input context consist of a common marking.

### BRIEF DESCRIPTION OF THE DRAWINGS

The disclosure is explained in more detail below using exemplary embodiments and in connection with the appended drawings in which:

FIG. 1 illustrates a single window that covers the display area of the configuration tool in accordance with an exemplary embodiment of the present disclosure; and

FIG. 2 illustrates a flowchart of method for managing and configuring field devices in an automation installation in accordance with an exemplary embodiment of the present disclosure.

### DETAILED DESCRIPTION

Exemplary embodiments of the present disclosure provide for making the management and configuration of field devices in an automation installation with a configuration tool as clear as possible.

Exemplary embodiments of the present disclosure are based on management and configuration of field devices in an automation installation with a configuration tool which is designed to physically detect a field device in the automation installation, logically incorporate the field device in the automation installation, and configure the field device in the automation installation. For this purpose, the configuration tool uses a predefined field-device-specific information packet which describes the functions and data of the field device and is displayed in an instantiated manner in windows or dialogs on a display means (e.g., monitor, display screen, or other suitable display device as desired).

According to an exemplary method described herein, the input windows of the same device entity and for the same input context are to be grouped by a common marking.

According to an exemplary device of the present disclosure, the input windows of the same device entity and for the same input context include the same marking.

According to an exemplary embodiment, the color of the window frames, the background color or graphical symbols can be provided as markings.

As a result, the windows are advantageously clearly assigned to the device entities and input contexts for the user.

According to an exemplary embodiment of the present disclosure, a special operating unit is provided for this purpose, which operating unit represents the input context and allows the input context to be applied or rejected. In this case, this special operating unit can be displayed either once or repeatedly, for example in each input window for the input context.

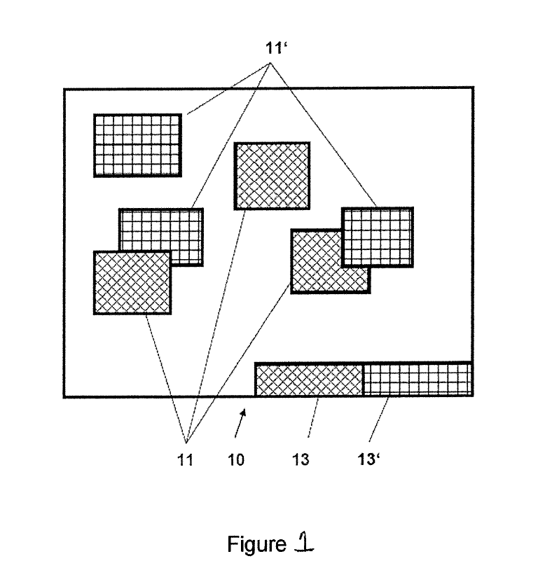

FIG. 1 illustrates a single window that covers the display area of the configuration tool in accordance with an exemplary embodiment of the present disclosure. As shown in FIG. 1, the single window 10 includes input windows 11 and 11′ of all EDD-based user interfaces that are arranged such that they can be positioned in any desired manner in this single window 10. The input windows 11 belong to input contexts of the same device entity and the input windows 11′ belong to input contexts of another device entity. The input windows 11 and 11′ are different on the basis of their affiliation with a device entity and are marked in an identical manner inside a device entity. The markings are illustrated by different hatching in FIG. 1. The color of the window frames, the background color or graphical symbols may be provided as markings.

In addition, the window 10 can have a first operating panel 13 associated with the first device entity and a second operating panel 13′ associated with the second device entity. On the basis of the associated device entity, the operating panels 13 and 13′ have the same markings as the user interfaces 11 and 11′.

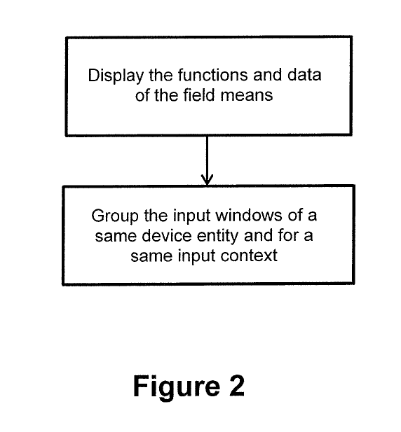

FIG. 2 illustrates a flowchart of method for managing and configuring field devices in an automation installation in accordance with an exemplary embodiment of the present disclosure. As already discussed, the configuration tool is configured to physically detect a field device in the automation installation, logically incorporate the field device in the automation installation, and configure the field device in the automation installation using a predefined field-device-specific information packet which describes functions and data of the field device. The method includes the steps of displaying the functions and data of the field device in an instantiated manner using input windows or dialogs on a display means and grouping the input windows of a same device entity and for a same input context by a common marking.

According to exemplary embodiments of the present disclosure the configuration tool including the special operating unit can be implemented in software and/or hardware including one or more of any known general purpose processor or integrated circuit such as a central processing unit (CPU), microprocessor, field programmable gate array (FPGA), Application Specific Integrated Circuit (ASIC), or other suitable programmable processing or computing devices or circuits as desired having an associated and suitable display monitor or display device. The general processor(s) can be configured to include and perform features of the exemplary embodiments of the present disclosure such as, a method for managing and configuring field devices in an automation installation, and thereby function as a special and unique processor. The features can be performed through program code encoded or recorded on the processor(s), or stored in a non-volatile memory device, such as Read-Only Memory (ROM), erasable programmable read-only memory (EPROM), or other suitable memory device or circuit as desired. In another exemplary embodiment, the program code can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Window
11, 11′ Input window
13, 13′ Operating panel

What is claimed is:

1. A method for managing and configuring field devices in an automation installation with a configuration tool configured to physically detect a field device in the automation installation, logically incorporate the field device in the automation installation, and configure the field device in the automation installation using a predefined field-device-specific information packet which describes functions and data of the field device, the method comprising:
displaying the functions and data of the field device in an instantiated manner using input windows or dialogs on a display means; and
grouping the input windows of a same device entity and for a same input context by a common marking.

2. A device for managing and configuring field devices in an automation installation, comprising:
a processor configured to execute a configuration tool that physically detects a field device in the automation installation, logically incorporated the field device in the automation installation, and configure the field device in the automation installation using a predefined field-device-specific information packet which describes the functions and data of the field device; and
display means for displaying the functions and data of the field device in an instantiated manner in input windows or dialogs, wherein the input windows of a same device entity and for a same input context consist of a common marking.

3. The device as claimed in claim 2, includes:
a special operating unit that represents an input context and allows the input context to be applied or rejected.
